(19) United States
(12) Patent Application Publication
(10) Pub. No.: US 2009/0096563 A1
(43) Pub. Date: Apr. 16, 2009

(54) INDUCTANCE

(75) Inventors: Ching-Fu HSUEH, Bade City (TW); Wen-Hsien CHEN, Guansi Township (TW); Ho-Chun LEE, Bade City (TW); Wei-Shun LIAO, Pingjhen City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/248,393

(22) Filed: Oct. 9, 2008

(30) Foreign Application Priority Data
Oct. 11, 2007 (TW) 96217001

(51) Int. Cl. H01F 27/02

(52) U.S. Cl. 336/90

(57) ABSTRACT

An inductance is provided. The inductance includes a metal core, a coil and a soft-magnetic colloid element. The coil is wound around the metal core. The soft-magnetic colloid element surrounds the coil.

This application claims the benefit of Taiwan application Serial No. 096217001, filed Oct. 11, 2007, the subject matter of which is incorporated herein by reference.

### BACKGROUND OF THE INVENTION

1. Field of the Invention

The invention relates in general to an inductance, and more particularly to a miniaturized inductance.

2. Description of the Related Art

A conventional inductance includes a metal core, a coil, an adhesive and a soft-magnetic metal. The coil wires around the metal core. The soft-magnetic metal is formed through casting and high temperature sintering processes. The adhesive is disposed between the coil and the soft magnetic metal to fix the soft-magnetic metal.

However, the trend of electronic devices is toward light weight and compact size. Therefore, all kinds of electronic components develop toward miniaturization. In a miniaturized inductance, the smaller the soft-magnetic metal is, the harder it is to form the miniaturized soft-magnetic metal. Furthermore, the defect rate is considerably high.

Besides, in a miniaturized electronic device, each electronic component occupies less and less space. When an inductance is disposed in a narrow and irregularly-shaped space, the designer has to resign the structure of the soft-magnetic metal. As a result, new mold is needed to manufacture a suitable soft-magnetic metal.

Therefore, conventional inductances no longer meet the trend of electronic devices toward light weight and compact size. It is very important for the industry to develop a suitable miniaturized inductance.

### SUMMARY OF THE INVENTION

The invention is directed to an inductance using a soft-magnetic colloid element to meet the development trend of electronic devices toward light weight and compact size.

According to the present invention, an inductance is provided. The inductance includes a metal core, a coil and a soft-magnetic colloid element. The coil is wound around the metal core. The soft-magnetic colloid element surrounds the coil.

The invention will become apparent from the following detailed description of the preferred but non-limiting embodiments. The following description is made with reference to the accompanying drawings.

### BRIEF DESCRIPTION OF THE DRAWINGS

FIG. 1A is a top view of an inductance according to a first embodiment of the present invention;

FIG. 1B is a cross-sectional view of the inductance in FIG. 1A along a cross-sectional line B-B′;

FIG. 2 illustrates a method of manufacturing the inductance according to the first embodiment of the present invention;

FIGS. 3A˜3F show steps in FIG. 2; and

FIGS. 4˜5 illustrate the inductances in other forms.

### DETAILED DESCRIPTION OF THE INVENTION

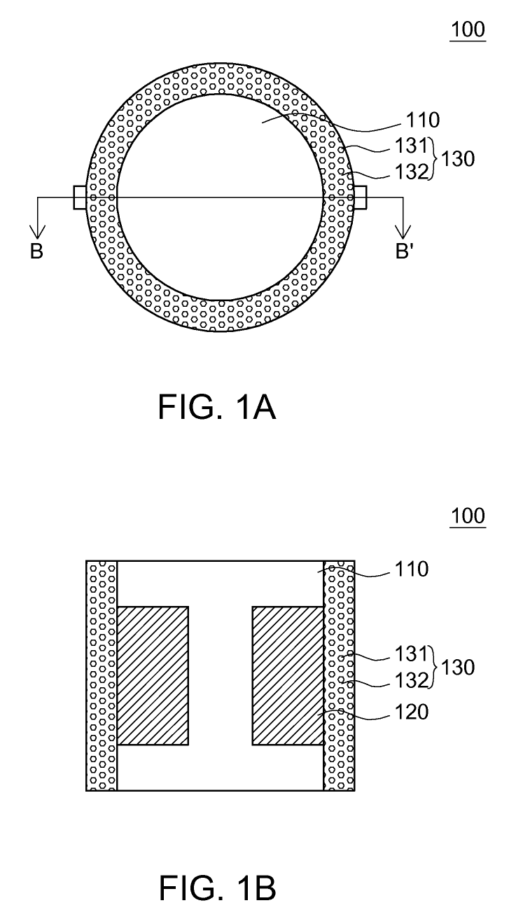

Please refer to FIGS. 1A-1B. FIG. 1A is a top view of an inductance according to a first embodiment of the present invention. FIG. 1B is a cross-sectional view of the inductance 100 in FIG. 1A along a cross-sectional line B-B′. The inductance 100 includes a metal core 110, a coil 120 and a soft-magnetic colloid element 130. The coil 120 is wound around the metal core 110. The soft-magnetic colloid element 130 surrounds the coil 120. The soft-magnetic colloid element 130 includes a compound rubber 131 and several soft magnet powders 132. The compound rubber 131 is colloidal when un-solidified. After solidified, the compound rubber 131 is solid. The soft magnet powders 132 are doped in the un-solidified compound rubber 131. After the compound rubber 131 is solidified, the soft magnet powders 132 are embedded in the solidified compound rubber 131.

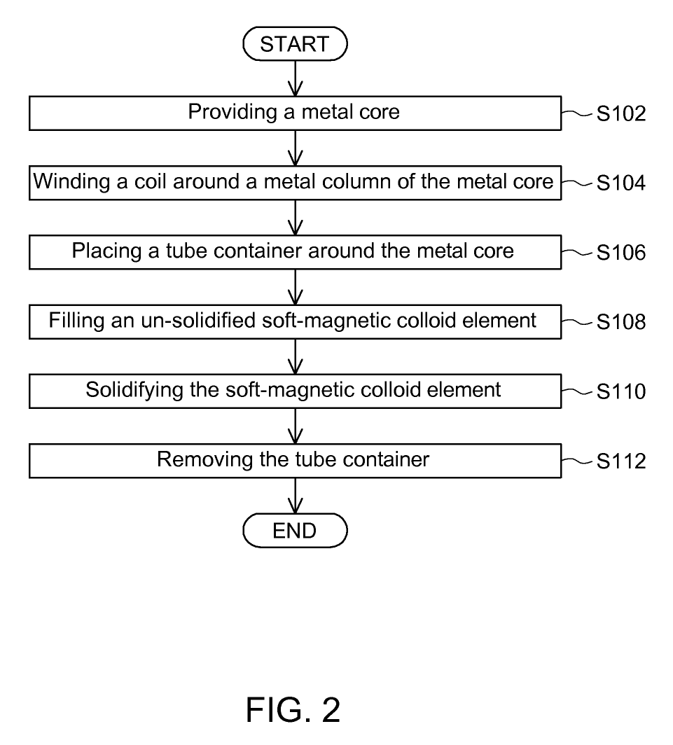

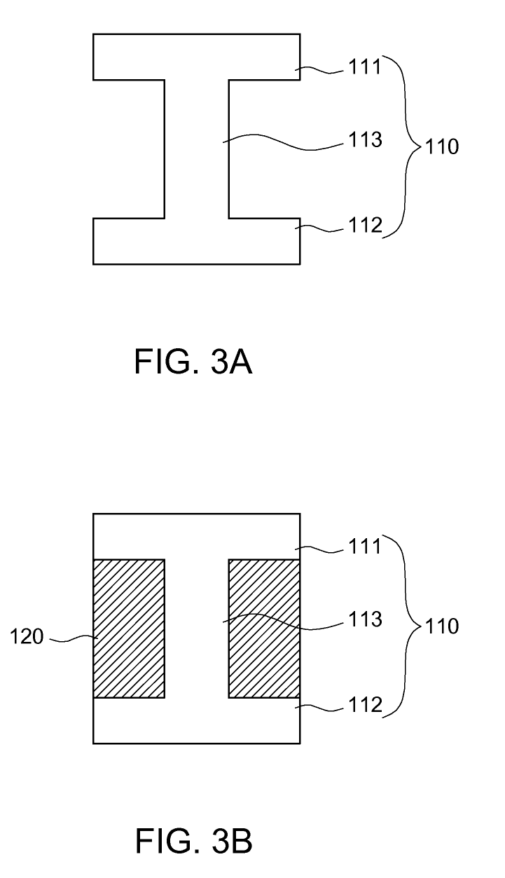

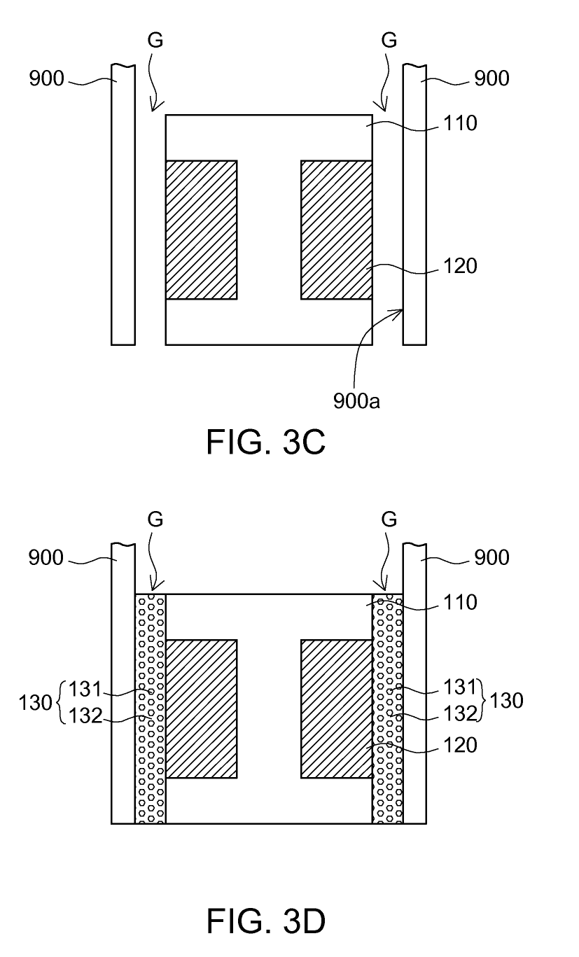

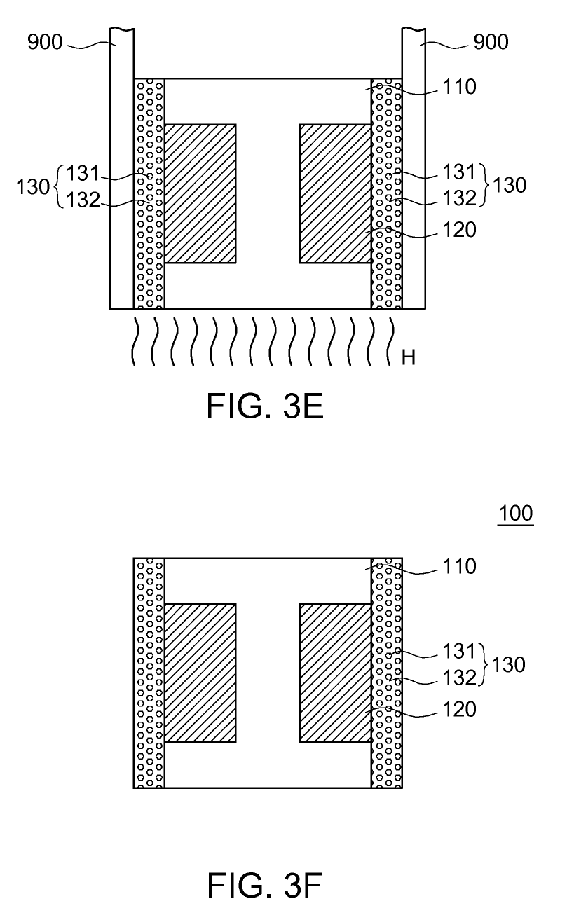

Please refer to FIG. 2 and FIGS. 3A˜3F. FIG. 2 illustrates a method of manufacturing the inductance 100 according to the first embodiment of the present invention. FIGS. 3A˜3F show steps in FIG. 2. First, as shown in FIG. 3A, the metal core 110 is provided in a step S102. In the present embodiment, the metal core 110 includes a first plate 111, a second plate 112 and a metal column 113. The metal column 113 connects and is disposed between the first plate 111 and the second plate 112.

Next, as shown in FIG. 3B, the coil 120 wires around the metal column 113 of the metal core 110 in a step S104.

Then, as shown in FIG. 3C, the metal core 110 is place inside a tube container 900 in a step S106. A space G is between the inner wall 900a of the tube container 900 and the coil 120.

Afterwards, as shown in FIG. 3D, the un-solidified soft-magnetic colloid element 130 is filled in a step S108. At this moment, the compound rubber 131 of the soft-magnetic colloid element 130 is un-solidified. The soft magnet powders 132 are filled in the space G between the inner wall 900a of the tube container 900 and the coil 120 along with the compound rubber 131. (The compound rubber 131 and the soft magnet powders 132 are shown in FIG. 1B.)

The compound rubber 131 is for example made of UV light glue, silicone and epoxy. The soft magnet powders 132 are for example made of manganese-zinc alloy and nickel-zinc alloy. The percentage of soft magnet powers 132 in the soft-magnetic colloid element 130 is about 50% to 80%.

After the soft-magnetic colloid element 130 is filled in the space G, the soft-magnetic colloid element 130 contacts the coil 120 and completely surrounds the entire coil 120. Preferably, the soft magnet powders 132 are evenly distributed in the compound rubber 131 so that the soft magnet powders 132 are evenly distributed around the coil 120.

No matter what size the metal core 110 is, the soft-magnetic colloid element 130 is able to surround the metal core 110 and the coil 120 smoothly. In other words, the soft-magnetic colloid element 130 is suitable for metal cores 110 in all sizes.

Sequentially, as shown in FIG. 3E, the soft-magnetic colloid element 130 is solidified in a step S110. The soft-magnetic colloid element 130 is solidified according to the material of the compound rubber 131. For example, when the compound rubber 131 is made of UV light glue, the soft-magnetic colloid element 130 is solidified by UV light. When the compound rubber 131 is made of epoxy, the soft magnetic rubber 130 is solidified by thermal cure. FIG. 3E illustrates the soft-magnetic colloid element 130 solidified by a heat source H. At this moment, the soft-magnetic colloid element 130 is formed and shaped according to the shape of the inner wall 900a of the tube container 900 and is fixed around the coil 120.

There is no need to use adhesive between the soft-magnetic colloid element 130 and the metal core 110 to fix the soft-magnetic colloid element 130. The usable space to wind the coil 120 is increased, and the manufacturing steps and material cost are reduced. In other words, thicker coil 120 can be used in the inductance 100, which increases the current limit.

Thereon, as shown in FIG. 3F, the tube container 900 is removed in a step S112. The inductance 100 according to the first embodiment is formed accordingly.

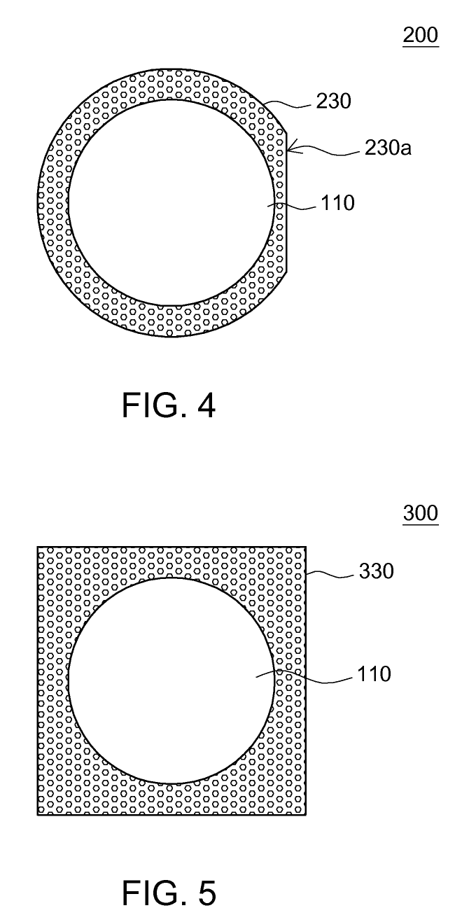

When crowded electronic components of the circuit board occupy less and less space, the predetermined disposition area of the inductance 100 is limited to the adjacent electronic components and thus becomes irregular. The soft-magnetic colloid element 130 can be formed into all kinds of shapes, which makes it easy to dispose the soft-magnetic colloid element 130 in the predetermined disposition area in all shapes. FIGS. 4-5 illustrate the inductances 200 and 300 in other forms. Take FIG. 4 and FIG. 5 for example. In FIG. 4, the soft-magnetic colloid element 230 of the inductance 200 has an inclined side 230a. In FIG. 5, the soft-magnetic colloid element 330 of the inductance 300 is a rectangular structure. The shapes of the inductances 200 and 300 are changed due to limits of the predetermined disposition area. However, there is no need to perform complicated and expensive processes such as casting and sintering. The inductance can be formed into all kinds of shapes, which increases the flexibility and lowers the manufacturing cost.

In the inductance disclosed in the above embodiment, the soft-magnetic colloid element is used for surrounding the coil. Therefore, the inductance has many advantages. Some of the advantages are described as follows.

First, the soft-magnetic colloid element only needs to be coated around the coil and can be shaped through a simple curing process. There is no need to perform complicated processes such as casting and sintering.

Second, no matter what kind of shape the predetermined disposition area is, the soft-magnetic colloid element can be formed into all kinds of shapes to match the predetermined disposition area. It is convenient to dispose the inductance in the predetermined disposition area in all kinds of shapes.

Third, no matter what size the metal core is, the soft-magnetic colloid element is able to surround the coil smoothly.

Fourth, there is no need to use adhesive between the soft-magnetic colloid element and the metal core to fix the soft-magnetic colloid element. The space to wire the coil is increased. Therefore, thicker coil can be used in the inductance, which increases the current limit.

Fifth, there is no need to use adhesive and perform casting and sintering processes. The material cost and the manufacturing cost of the inductance are significantly lowered.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A inductance comprising:
a metal core;
a coil wound around the metal core; and
a soft-magnetic colloid element surrounding the coil.

2. The inductance according to claim 1, wherein the soft-magnetic colloid element comprises:
a compound rubber; and
a plurality of soft magnet powders doped in the compound rubber.

3. The inductance according to claim 2, wherein the soft magnet powders are distributed evenly around the coil.

4. The inductance according to claim 2, wherein the material of the compound rubber comprises UV light glue, silicone and epoxy.

5. The inductance according to claim 2, wherein the material of the soft magnet powders comprises manganese-zinc alloy and nickel-zinc alloy.

6. The inductance according to claim 2, wherein the percentage of soft magnet powers in the soft-magnetic colloid element is about 50% to 80%.

7. The inductance according to claim 1, wherein the soft-magnetic colloid element contacts the coil.

8. The inductance according to claim 1 being disposed in a predetermined disposition area, the shape of the soft-magnetic colloid element matching the predetermined disposition area.

9. The inductance according to claim 1, wherein the soft-magnetic colloid element completely surrounds the coil.
